(19) United States
(12) Patent Application Publication
(10) Pub. No.: US 2023/0073268 A1
(43) Pub. Date: Mar. 9, 2023

(54) Server Device And Method For Providing A Vehicle Function Via A Vehicle-External Communication Device

(71) Applicant: AUDI AG, Ingolstadt (DE)

(72) Inventors: Christoph FRANKE, Ingolstadt (DE); Kevin KONRADT, Lenting (DE)

(73) Assignee: AUDI AG, IngoIstadt (DE)

(21) Appl. No.: 17/929,195

(22) Filed: Sep. 1, 2022

(30) Foreign Application Priority Data
Sep. 7, 2021 (DE) 10 2021 123 075.6

(51) Int. Cl. B60W 40/09; B60W 50/10

(52) U.S. Cl. CPC B60W 40/09; B60W 50/10; B60W 2540/215

(57) ABSTRACT

The invention relates to a server device and a to method for providing a vehicle function via a vehicle-external communication device, wherein the server device is used to detect user interactions with a motor vehicle, wherein a user behavior profile is learned by a learning function of the server device by means of the detected user interactions, and one or more vehicle functions from a predetermined function pool of the motor vehicle are determined via the learning function by means of the user behavior profile, wherein, if an event criterion is present for one of the determined vehicle functions, a communication function of the server device is offered for performing the corresponding vehicle function via the vehicle-external communication device.

### TECHNICAL FIELD

The present disclosure relates to a method for providing a vehicle function via a vehicle-external communication device and to a server device for carrying out said method.

### BACKGROUND

It is known that vehicle data can be queried remotely via an app or vehicle functions can be remotely controlled via the app. For example, the state of charge of a high-voltage battery can be queried or the engine-independent heater can be activated. The information that can be called up and the vehicle functions that can be controlled correspond to a predetermined set of functions that is usually displayed and offered by means of predetermined menus, wherein clarity and/or a range of functions are severely limited by the form of presentation using predetermined menus. It is desirable to offer all vehicle functions included in a function pool of the motor vehicle, wherein a user quickly loses an overview of all vehicle functions and often would only want to use vehicle functions that are of interest to him.

A method and a device for predictive driver assistance are disclosed in DE 10 2017 105 885 A1. A system includes a processor configured to predict upcoming driver behavior based on a correlation between received context variables and previously observed driving behavior. The processor is also configured to request confirmations that predicted behavior is intended by a driver. Further, the processor is configured, upon confirmation of receipt, to change a display in the vehicle to include a control element or feature that is relevant to the predicted behavior.

US 2016/0371050 A1 discloses a device for managing a communication on a mobile communication device based on a user's behavior.

A method for providing improved navigation information in a motor vehicle in response to a finding of driver confusion is disclosed in US 2017/0268897 A1. A behavior of a driver is monitored, specifically whether the driver is confused based on the driver's behavior, and additional points of interest data are provided to the driver if it is determined that the driver is confused.

### BRIEF DESCRIPTION OF DRAWINGS

The accompanying drawings, which are incorporated herein and form a part of the specification, illustrate the embodiments of the present disclosure, and together with the description, further serve to explain the principles of the embodiments and enable a person skilled in the pertinent art to make and use the embodiments, individually, or as a combination thereof.

FIG. 1 shows a server device, according to an exemplary embodiment.

FIG. 2 is a schematic method diagram, according to an exemplary embodiment.

### DETAILED DESCRIPTION

The object of the present disclosure is to improve a provision of vehicle functions via a vehicle-external communication device.

This object is achieved by the independent claims. Advantageous developments of the present disclosure are disclosed in the dependent claims, the following description and the drawings.

The present disclosure is based on the idea that information and/or vehicle functions that are relevant and of interest to the user are made available to the user by means of a learned communication with the motor vehicle depending on user behavior.

The present disclosure provides a method for making available a vehicle function via a vehicle-external communication device, wherein a server device is used to detect user interactions with a motor vehicle, wherein a user behavior profile is learned by a learning function of the service device by means of the detected user interactions, wherein one or more vehicle functions from a predetermined function pool of the motor vehicle are determined via the learning function by means of the user behavior profile, wherein, if an event criterion is present for one of the determined vehicle functions, a communication function of the server device is offered for performing the corresponding vehicle function via the vehicle-external communication device.

In other words, a server device can capture user interactions with a motor vehicle and learn a behavior of the user therefrom. The behavior of the user can be detected by a learning function of the server device and be stored in a user behavior profile. Using the user behavior profile, the learning device can select from a predefined function pool of the motor vehicle, in which all available vehicle functions of the motor vehicle can be present, those vehicle functions which, according to the user behavior profile, are of interest to the user and/or are used frequently.

If an event criterion that matches the vehicle function occurs for one of these determined vehicle functions, a communication function of the server device can start a communication with the vehicle-external communication device and offer the corresponding vehicle function to be performed. This means that the communication function in the form of a dialog can send a message to the communication device as to whether the vehicle function is to be performed.

For example, the learning function can be an artificial intelligence, in particular a neural network, which can analyze the user interactions with the motor vehicle and thus learn the user behavior profile. The user interactions can be, for example, an interaction of a user, in particular a driver, during and/or before or after a trip in the motor vehicle, and/or the user interactions can be a control and/or communication with the motor vehicle via the vehicle-external communication device. The communication function can be a digital assistant, which can interpret and evaluate text input and/or voice input, wherein responses and/or vehicle functions can be provided to the communication device via the communication function by means of text output and/or voice output. User behavior profiles for the vehicle can preferably also be learned for a plurality of users, wherein each user is thus provided with his individual vehicle functions from the predefined function pool of all vehicle functions. The event criterion can be present, for example, if a vehicle sensor, the server device and/or the vehicle-external communication device acquires data that indicate the occurrence of a predetermined event for the particular vehicle function.

For example, it is possible to store as a learned behavior in the user behavior profile that a user locks the motor vehicle after parking it on the side of the road. In this case, the event criterion can be that the motor vehicle determines that after the motor vehicle was parked someone forgot to lock it, wherein the communication function can control the communication device, for example, with the sentence: “Did you forget to lock me?”, preferably with the addition: “Should I lock for you?” By confirming this request, the server device, for example, can control the motor vehicle via a vehicle interface in order to lock the motor vehicle. In another user behavior profile, it can be learned, for example, that the motor vehicle is parked in a garage and is usually not locked while it is in the garage. In such a case, the communication device would not send a query, for example.

The vehicle-external communication device can be embodied as a mobile terminal and/or smart speaker and/or voice assistant, wherein the mobile terminal can be embodied as a smartphone, a smartwatch, a tablet PC and/or a laptop. The server device can be a computer, preferably a computer cloud, or a server on the Internet. Using a server device has the advantage that the learning function and the communication function can be quickly adjusted for all users and in-vehicle data can remain on the server device, which increases security and/or data protection. The vehicle is preferably designed as a motor vehicle, in particular as a passenger vehicle or truck, or as a passenger bus or motorcycle.

The advantage of the present disclosure is that the function pool with all vehicle functions can be pre-filtered for a user, so that only the vehicle functions that are of interest to him are offered. On the one hand, this leads to the user building a stronger connection to the ranges of functions in the motor vehicle, because they react to him by being made available in a customized manner. On the other hand, it can be achieved that a larger function pool of vehicle functions can be made available to the user, because the pre-filtering relieves him of a complex selection of the vehicle functions. Provision of vehicle functions via a vehicle-external communication device can thus be improved.

The present disclosure also comprises embodiments which yield additional advantages.

One embodiment provides that the offered vehicle function is confirmed by means of the communication device, wherein the motor vehicle is controlled by the server device via a vehicle interface to carry out the confirmed vehicle function. This means that the communication initiated by the server device with the communication device can be used to confirm the offered vehicle function. For example, the server device can offer in dialog form to activate an air conditioning device of the motor vehicle, wherein this offer may be confirmed by means of the communication device via an input, in particular via a text input and/or voice input and/or via manual selection of a response option. The communication function of the server device can interpret this confirmation and control the motor vehicle via a vehicle interface to carry out the vehicle function. After the vehicle function has been carried out in the motor vehicle, feedback can preferably be provided by the motor vehicle, which feedback the server device can forward to the communication device. For example, a notification can be sent to the communication device that the vehicle function has been performed. This embodiment has the advantage that the vehicle functions that are offered can be controlled externally to the vehicle.

A further embodiment provides that the user behavior profile is learned by the user interactions that a user carries out with the vehicle functions that are offered. In other words, the learning function can determine what a user's behavior and responses are to offered vehicle functions. For example, a plurality of vehicle functions from the predefined function pool can first be offered to the user before the user behavior profile can be refined via the learning function. Depending on the user interaction with the particular vehicle functions that are offered, the function pool can then be filtered to determine which vehicle functions are of interest to the user. For example, if there is no feedback to a vehicle function that is offered, the learning function can determine that this is of no interest to the user. A user can also actively input via the communication device if a vehicle function should no longer be offered. The function offering can thus be constantly improved and tailored to the user.

In one advantageous embodiment, it is provided that vehicle functions to be performed automatically are determined by the user interaction with the vehicle functions that are offered, wherein the motor vehicle is controlled by the server device to perform the vehicle functions to be performed automatically without user interaction. Depending on the user behavior profile, it is possible to determine which vehicle functions are to be carried out automatically without user interaction. For example, in the case of a vehicle function that is carried out regularly, in particular at specific locations, at specific times and/or under specific weather conditions, a vehicle function can be started automatically by the server device in the motor vehicle. The communication function can preferably offer a query beforehand as to whether the particular vehicle function is to always be carried out automatically when a specific event criterion occurs. This embodiment has the advantage that vehicle functions can be automated, which increases comfort for a user of the motor vehicle.

A further embodiment provides that a behavior of a user in the motor vehicle during operation of the motor vehicle is detected as a user interaction and/or wherein a control of vehicle functions via the vehicle-external communication device is detected as a user interaction. In this way, preferences and behavior of the user can be determined during a trip in the motor vehicle and/or by direct activation of vehicle functions via the vehicle-external communication function. Controlling vehicle functions via the vehicle-external communication function can include, for example, activating an air conditioning device of the motor vehicle and/or locking the motor vehicle. The user interactions that are carried out during operation of the motor vehicle and that are carried out from outside the motor vehicle using the communication device can preferably be merged in order to provide a better and more extensive data basis for the learning function.

A further specific embodiment provides for vehicle sensor data of the motor vehicle to be checked for the presence of the event criterion. In other words, vehicle sensor data can be determined by one or more vehicle sensors of the motor vehicle and can be checked for the presence of the event criterion. For example, a position of the motor vehicle, a weather condition or other states of the motor vehicle can be determined by which the communication with the communication device can be initiated. In this way, the motor vehicle can automatically start the communication and report specific events when predefined vehicle sensor data are present. For example, vehicle sensors can detect an accident with the parked vehicle, wherein this can be communicated to the user without the user having to actively retrieve this information. Alternatively or additionally, data from the server device and/or the vehicle-external communication device can also be checked to determine whether the event criterion has occurred.

A further embodiment provides that the communication function offers communication with the vehicle-external communication device in a dialog format. A dialog format means a dialog-type communication between the server device and the vehicle-external communication device, which communication not only has keywords using a menu-type structure, but also provides a dialog in a syntax based on grammatical laws. In this way, the vehicle functions offered are preferably embedded in a sentence structure. The communication function can preferably also evaluate responses in dialog format and thus detect user behavior. The communication function can preferably provide a text output/input and/or a voice output/input for the vehicle-external communication device. This means that the communication function can be in the form of an interpreter/voice assistant that can detect and generate text and speech. This embodiment has the advantage that a particularly intuitive control of the vehicle functions can be provided.

Provision is preferably made for the communication function to adapt a communication behavior of the dialog format depending on the user behavior profile. In this way, language usage in the dialog with the user can be adapted depending on the responses and the behavior of the user. In particular, a dialog format with a user can be, for example, formal or colloquial depending on the user behavior profile.

A further embodiment provides that the server device determines a position of a user, wherein the vehicle function is offered for performing only if the user is outside the motor vehicle. For example, the communication device can transmit a position of the user to the server device, wherein the server device, together with a position of the motor vehicle, is able to determine whether the user is inside or outside the motor vehicle, wherein the vehicle functions are only offered if the user is outside the motor vehicle. This embodiment offers the advantage that a user is not distracted by the communication while driving, which improves safety.

According to an embodiment, a server device is also provided, wherein the server device is designed to carry out a method according to any of the preceding embodiments. The server device can have a learning function, by means of which a user behavior profile can be learned from recorded user interactions, wherein the learning function of the user behavior profile is able to determine one or more vehicle functions from a predetermined function pool of a motor vehicle, wherein the server device is able to detect a communication function for providing a vehicle function to a vehicle-external communication device when an event criterion for one of the determined vehicle functions is present. This yields the same advantages and possible variations as with the method.

The server device can have a data processing device or a processor device that is configured to implement an embodiment of the method according to the present disclosure. For this purpose, the processor device can have at least one microprocessor and/or at least one microcontroller and/or at least one FPGA (field programmable gate array) and/or at least one DSP (digital signal processor). Furthermore, the processor device can have a program code which is configured to carry out the embodiment of the method according to the present disclosure when performed by the processor device. The program code can be stored in a data memory of the processor device.

The present disclosure also includes further developments of the server device according to an embodiment which have features such as those previously described in connection with the developments of the method according to the embodiment. For this reason, the corresponding developments of the server device according to embodiments are not described again here.

The present disclosure also comprises the combinations of the features of the described embodiments. The embodiment also comprises realizations that each have a combination of the features of a plurality of the described embodiments, provided that the embodiments were not described as mutually exclusive.

In the following, embodiments of the present disclosure are described, in which:

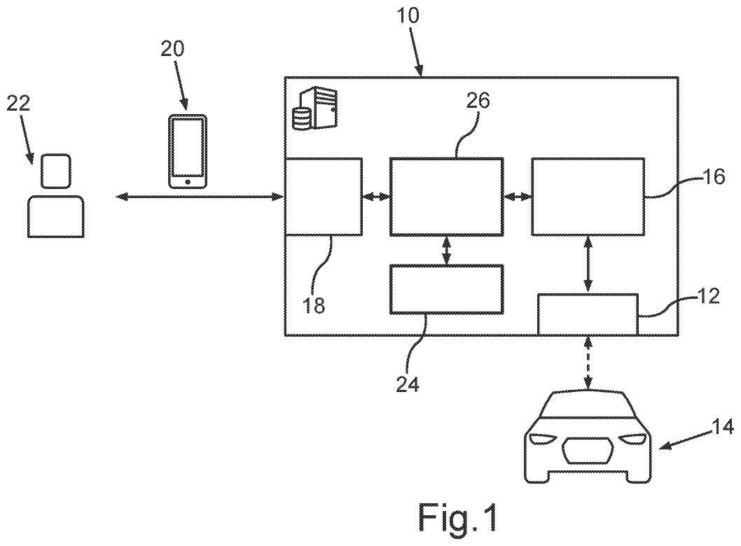

FIG. 1 shows a server device according to an exemplary embodiment;

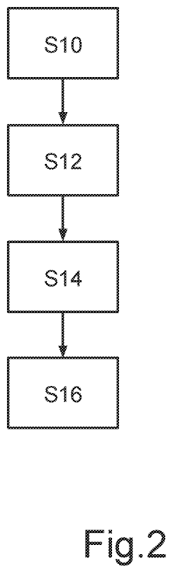

FIG. 2 is a schematic method diagram according to an exemplary embodiment.

The embodiments described below are preferred embodiments of the present disclosure. In the embodiments, the described components of the embodiments each represent individual features of the present disclosure which should be considered independently of one another and which each develop the embodiments independently of one another. The disclosure is therefore also intended to comprise combinations of the features of the embodiments other than those presented. Furthermore, the described embodiments may also be supplemented by further, previously described features of the present disclosure.

In the drawings, the same reference signs denote functionally identical elements.

FIG. 1 shows a schematically illustrated server device 10 according to an exemplary embodiment. The server device 10 can be a backend on the Internet, in particular from a motor vehicle manufacturer, which can access a motor vehicle 14 via a vehicle interface 12. In particular, the server device 10 can control vehicle functions of the motor vehicle 14 to be performed in the motor vehicle 14, wherein it is possible for all vehicle functions available in motor vehicle 14 to be stored in a predefined function pool 16 on the server device 10. In other words, the function pool 16 on the server device 10 is a reference to the vehicle functions present in the motor vehicle 14.

Furthermore, the server device 10 can communicate with a vehicle-external communication device 20 of a user 22 via a communication interface 18 and thus provide remote control of vehicle functions via the communication device 20. The vehicle-external communication device 20 can be a mobile terminal, in particular a smartphone, and/or a smart speaker or digital assistant.

In order for the user 22 not to have to tediously search the function pool 16 for vehicle functions that are of interest to him or to configure individual vehicle functions in a laborious manner, the server device 10 is designed to automatically determine the vehicle functions relevant to the user 22 and/or to configure these vehicle functions.

For this purpose, the server device 10 has a learning function 24 that records user interactions with the motor vehicle 14 and learns a user behavior profile. The user behavior profile can include preferences and behavior of the user 22, in particular which vehicle functions are frequently used by the user 22 and which vehicle functions could be of interest. To determine the user behavior profile, the learning function 24 can, on the one hand, record a behavior of the user 22 during a trip in the motor vehicle 14 and/or learn said behavior from a remote control of vehicle functions using the communication device 20. Preferably, the remote control of the vehicle functions can be provided by means of the communication device 20 in a dialog format, wherein the server device 10 can have a communication function 26 which is designed to interpret text inputs and/or voice inputs and to determine therefrom which vehicle functions of the function pool 16 in the vehicle 14 are to be carried out.

After the vehicle functions that are of interest to the user 22 have been determined from the function pool 16, they can be monitored to determine whether a predetermined event occurs that automatically initiates communication with the vehicle-external communication device 20. For example, a vehicle sensor of the motor vehicle 14, which sends measured vehicle sensor data to the server device 10, can meet an event criterion for the particular vehicle function, as a result of which the communication function 26 controls the communication device 20 via the communication interface 18 in order to offer the corresponding vehicle function for the user 22 to perform. This can also preferably be carried out by the communication function 26 in dialog format, in particular as text output and/or voice output.

For example, the learning function 24 can have previously determined from a behavior of the user 22 that he is adjusting the air conditioning of the motor vehicle 14 to room temperature when driving to work. After the user behavior profile has learned this behavior, a vehicle sensor of the motor vehicle 14 can, for example, determine at a similar time on another day that the temperature in the motor vehicle 14 is below room temperature, wherein this vehicle sensor data can be transmitted to the server device 10. Because it is known from the user behavior profile that room temperature is usually desired in the motor vehicle 14 when driving to work, the communication function 26 can generate a message with a query for the communication device 20 as to, for example, whether a heating system in the motor vehicle 14 is to be activated. In response to this, the user 22 can confirm this offered vehicle function via the communication device 20, wherein the server device 10 can then use the vehicle interface 12 to control the motor vehicle 14 to carry out the vehicle function, i.e., the heating system of the motor vehicle 14 can be activated via the server device 10.

Communication between the user and the server device 10 can preferably be adapted to a communication behavior of the user 22 in that the learning function 24 analyzes a sentence structure and selected words of the user 22 and provides a communication behavior to the communication function 26 for imitation.

Furthermore, the learning function 24 can preferably further learn and refine the user behavior profile in that the learning function 24 analyzes how the user 22 reacts to the vehicle functions that are offered. In particular, the learning function 24 can also determine whether certain offered vehicle functions to be carried out are always confirmed by the user 22, wherein these vehicle functions can then be carried out automatically and without being offered beforehand via the communication device 20.

Overall, the user 22 can thus be provided with an expanded function pool 16, wherein the server device 10 automatically determines via the learning function 24 which of the vehicle functions from the function pool 16 are actually of interest to the user 22.

FIG. 2 is a schematic method diagram for providing a vehicle function via a vehicle-external communication device 20 according to an exemplary embodiment. The vehicle-external communication device 20 can be a mobile terminal and/or a smart speaker or voice assistant which is linked to a motor vehicle 14 via a server device 10. In a step S10, the server device 10 can detect user interactions with the motor vehicle 14, wherein a user behavior profile can be learned by a learning function 24 of the server device 10 by means of the detected user interactions.

In a step S12, the learning function 24 can use the user behavior profile to determine one or more vehicle functions from a predefined function pool 16 of the motor vehicle 14, which functions a user 22 uses frequently and which are of interest to him.

In a step S14, it can be checked whether there is an event criterion for one of the determined vehicle functions, for example whether it is detected from vehicle sensor data of the motor vehicle 14 that a predefined situation has occurred. If this is the case, a communication function 26 of the server device 10 can offer the corresponding vehicle function to be performed via the vehicle-external communication device 20.

Finally, the offered vehicle function can be confirmed in a step S16 by means of the communication device 20, wherein the motor vehicle 14 can be controlled by the server device 10 via a vehicle interface 12 to carry out the confirmed vehicle function.

It is preferably provided that the method shown above and the offer to perform the vehicle function are only carried out if the user 22 is outside of the motor vehicle 14, wherein for this purpose the server device 10 can determine a position of the user, in particular of the communication device 20, which can be compared to a position of the motor vehicle 14 to determine whether the user 22 is inside or outside the motor vehicle 14.

In another exemplary aspect, the user 22 may communicate with the backend (server device 10) via any communication medium (communication device 20). The backend uses the function pool 16 and its vehicle interface 12 with the vehicle 14. A communication function 26 provides queries to the user 22 and interpretation functions for the user's responses. The communication function 26 can control the vehicle functions in the function pool 16 corresponding to the responses of the user 22.

The learning function 24 can also read this communication. The learning function 24 analyzes the response of the user 22 to the offered function and determines his preferences and behavior. With this information, the learning function 24 can trigger the communication function 26 to offer a vehicle function to the user 22 when the user is likely to want to use it.

Overall, the examples show how the present disclosure can provide a driver-specific range of functions.

1-10. (canceled)

11. A method for providing a vehicle function via a vehicle-external communication device comprising:
detecting, via a server device, user interactions with a motor vehicle;
learning, via the server device, a user behavior profile by a learning function using the detected user interactions;
determining, via the server device, one or more vehicle functions from a predetermined function pool of the motor vehicle based on the learning function based on the user behavior profile; and
wherein, based an event criterion being present for one of the determined vehicle functions, performing, via the server device, a communication function of the server device for the corresponding vehicle function via the vehicle-external communication device.

12. The method according to claim 11, wherein the vehicle function that is offered is confirmed by the communication device, wherein the motor vehicle is controlled by the server device via a vehicle interface to carry out the confirmed vehicle function.

13. The method according to claim 11, wherein the user behavior profile is learned via the user interactions which a user performs with the vehicle functions that are offered.

14. The method according to claim 13,
wherein vehicle functions to be performed automatically are determined by the user interaction with the vehicle functions that are offered, and
wherein the motor vehicle is controlled by the server device to carry out the vehicle functions to be performed automatically without user interaction.

15. The method according to claim 11,
wherein a behavior of a user in the motor vehicle during operation of the motor vehicle is detected as a user interaction, and
wherein a control of vehicle functions via the vehicle-external communication device is detected as a user interaction.

16. The method according to claim 11, wherein vehicle sensor data of the motor vehicle are checked for the presence of the event criterion.

17. The method according to claim 11, wherein the communication function provides communication with the vehicle-external communication device in a dialog format.

18. The method according to claim 17, wherein the communication function adapts a communication behavior of the dialog format depending on the user behavior profile.

19. The method according to claim 11,
wherein the server device determines a position of a user, and
wherein the vehicle function is offered for performing only if the user is outside the motor vehicle.

20. A server device, wherein the server device is configured to carry out a method comprising:
detecting user interactions with a motor vehicle;
learning a user behavior profile by a learning function by means of the detected user interactions;
determining one or more vehicle functions from a predetermined function pool of the motor vehicle based on the learning function based on the user behavior profile; and
wherein, based on an event criterion being present for one of the determined vehicle functions, performing a communication function of the server device for the corresponding vehicle function via the vehicle-external communication device.
